(19) United States
(12) Patent Application Publication
(10) Pub. No.: US 2006/0233107 A1
(43) Pub. Date: Oct. 19, 2006

(54) Method and apparatus for monitoring surges in busy and no answer conditions in a communication network

(76) Inventors: Marian Croak, Fair Haven, NJ (US); Hossein Eslambolchi, Los Altos Hills, CA (US)

Correspondence Address: Mr. S.H. Dworetsky;AT&T Corp., Room 2A-207, One AT&T Way, Bedminster, NJ, 07921, US

(21) Appl. No.: 11/109,098

(22) Filed: Apr. 19, 2005

(51) Int. Cl. H04J 1/16; H04L 12/66; H04L 12/56; H04L 12/54

(52) U.S. Cl. 370/235; 370/352; 370/401; 370/428

(57) ABSTRACT

A method and apparatus for enabling edge components, such as Border Element, to respond to access failures in a more intelligent manner by measuring the busy and/or no answer state conditions for attempted calls and generating alarms when these states reach a predetermined threshold is disclosed. In one embodiment, additionally capacity for handling a surge in certain traffic flow to various network elements, e.g. voice mail servers, can be automatically enabled when such alarms are received.

The present invention relates generally to communication networks and, more particularly, to a method and apparatus for monitoring surges in busy and no answer conditions in packet networks, e.g. Voice over Internet Protocol (VoIP) networks.

### BACKGROUND OF THE INVENTION

Endpoints registered with a network provider, e.g., a VoIP network provider, will traverse various access links to connect to the network service. Occasionally these access links experience failures preventing the endpoints from sending and receiving calls. Without knowledge that there is an access link failure, the components at the edge of the VoIP network that communicate with these endpoints over the access links will typically redirect traffic destined for these endpoints to alternative destinations such as voice mail. If these busy and no answer conditions are not monitored and handled carefully, it may overwhelm network elements, such as Media Servers (MS), in the VoIP network that may further lead to network disruptions in the VoIP network. Broadly defined, a Media Server (MS) is a special server that typically handles and terminates media streams, and to provide services such as announcements, bridges, transcoding, and Interactive Voice Response (IVR) messages.

Therefore, a need exists for a method and apparatus for monitoring surges in busy and no answer conditions in a packet network, e.g., a VoIP network.

### SUMMARY OF THE INVENTION

In one embodiment, the present invention enables edge components, such as Border Elements, to respond to access failures in a more intelligent manner by measuring the busy and/or no answer state conditions for attempted calls and generating alarms when these states reach a predetermined threshold. Additionally capacity for handling a surge in certain traffic flow to various network elements, e.g. voice mail servers, can be automatically enabled when such alarms are received.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of monitoring surges in busy and no answer conditions in a VoIP network of the present invention;

FIG. 3 illustrates a flowchart of a method for monitoring surges in busy and no answer conditions in a VoIP network of the present invention; and

FIG. 4 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

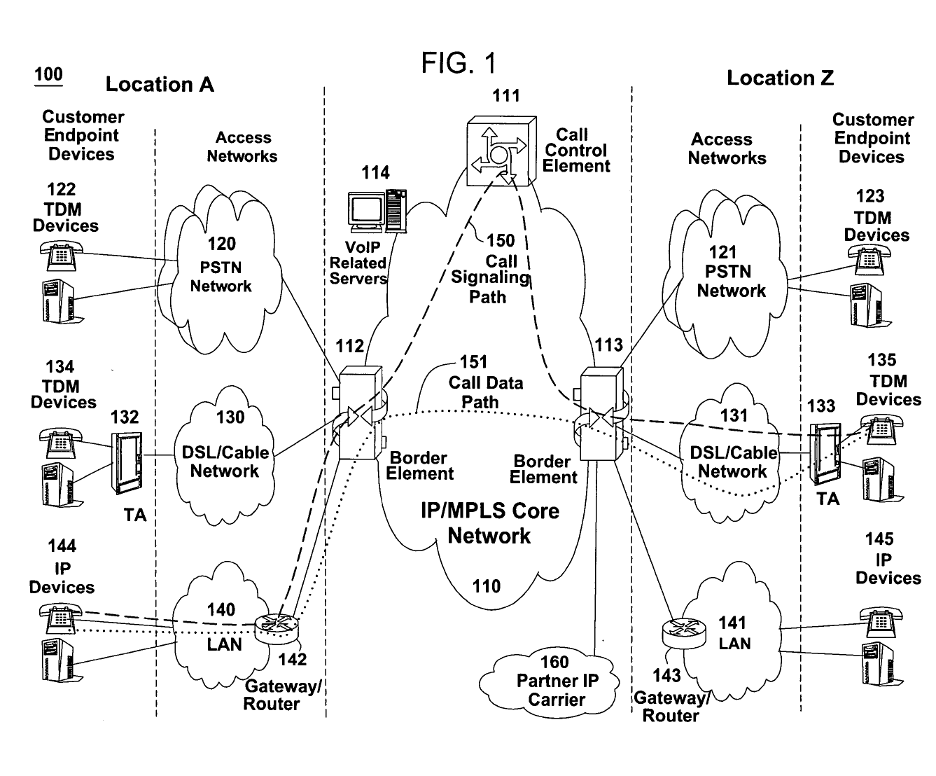

To better understand the present invention, FIG. 1 illustrates an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VolP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Endpoints registered with a network provider, e.g., a VoIP network provider, will traverse various access links to connect to the network service. Occasionally these access links experience failures preventing the endpoints from sending and receiving calls. Without knowledge that there is an access link failure, the components at the edge of the VoIP network that communicate with these endpoints over the access links will typically redirect traffic destined for these endpoints to alternative destinations such as voice mail. If these busy and no answer conditions are not monitored and handled carefully, it may overwhelm network elements, such as Media Servers (MS), in the VoIP network that further leads to network disruptions in the VoIP network. Broadly defined, a Media Server (MS) is a special server that typically handles and terminates media streams, and to provide services such as announcements, bridges, transcoding, and Interactive Voice Response (IVR) messages.

To address this criticality, the present invention enables edge components, such as Border Elements, to respond to access failures in a more intelligent manner by measuring the busy and/or no answer state conditions for attempted calls and generating alarms when these states reach a predetermined threshold. In one embodiment, additionally capacity for handling a surge in certain traffic flow to various network elements, e.g. voice mail servers, can be automatically enabled when such alarms are received.

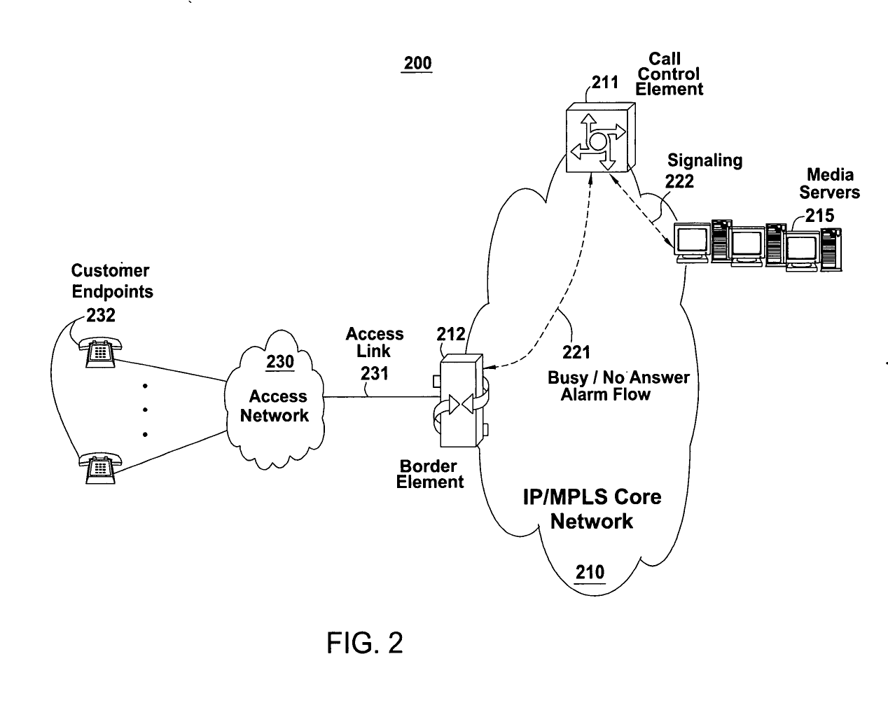

FIG. 2 illustrates an example of monitoring surges in busy and no answer conditions in a packet network 210, e.g., a VoIP network. Whenever customer endpoints 232 are busy due to ongoing phone calls or unanswered due to no one is able to answer calls, BE 212 will respond by sending signaling messages to CCE 211 to indicate the busy and/or no answer conditions of the called endpoints. These are normal conditions that occur in the VoIP network on a daily basis. However, when access network 230 or access link 231 are down, the same call conditions can be generated by BE 212 because BE 212 cannot reach the called endpoints 232. BE 212 treats calls that cannot be completed to the called endpoints due to access network or link failure as busy or no answer calls. When a failure occurs in access network 230 or access link 231, the failure can generate a large number of busy or no answer calls which are not typical during normal operations of the VoIP network. This surge in busy and no answer calls can potentially overload Media Servers (MS) 215 because these calls are generally redirected by CCE 211 to MS 215 to voice mail boxes for these busy and no answer calls. In order to avoid overload conditions in the VoIP network due to access network or link failure, BE 212 can keep track of the volume of busy and no answer calls within a specified period of time. The length of the specified period of time is a configurable parameter that can be set by the network provider, e.g., one minute, five minutes, one hour and so on. If the volumes of busy and no answer calls exceed a pre-defined threshold (e.g., a factor of the normal volumes of busy and no answer, e.g., five times the normal volumes and so on) also set by the network provider, BE 212 can raise an alarm, using flow 221, to CCE 221 to warn the network provider of a potential or impending overload conditions in the VoIP network. In turn, CCE 221, if necessary, can take corrective action by activating at least one standby MS, using flow 222, to help cope with the increased voice mail volume due to the access network or link failure.

In one embodiment, the standby network elements are hot standby elements or components. A hot standby component is a secondary component which is running simultaneously with the primary component that can, within a very short period of time (e.g., in the range of mili-seconds), be switched over to backup or augment the primary component. When used in the backup mode, the hot standby component can simply take over the function of the primary component if the primary component fails. When used in the augmentation mode, the hot standby component can augment the processing capacity of the primary component when the primary component is getting overloaded.

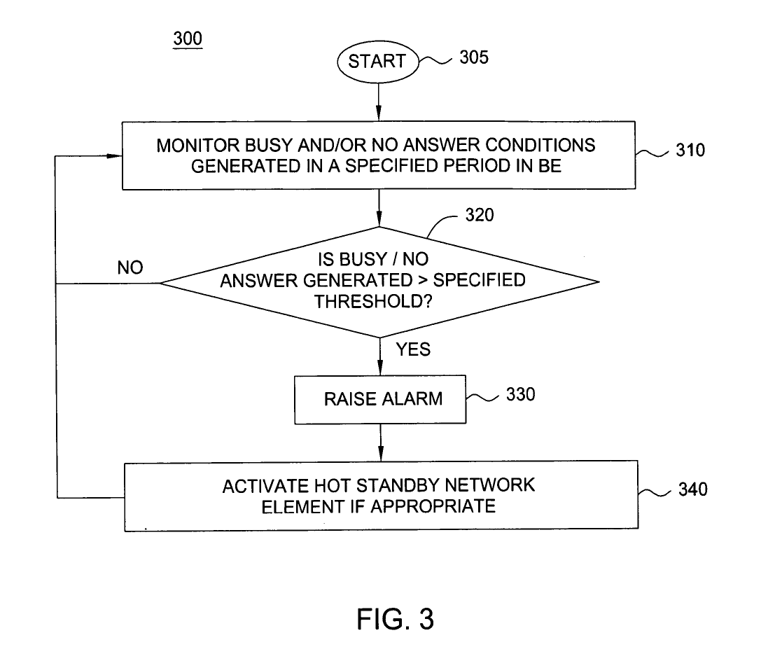

FIG. 3 illustrates a flowchart of a method 300 for monitoring surges in busy and/or no answer conditions in a packet network, e.g., a VoIP network. Method 300 starts in step 305 and proceeds to step 310.

In step 310, the method 300 monitors the volume of busy and/or no answer conditions generated in a specified period in a BE. In step 320, the method checks if the volumes of busy and no answer conditions have exceeded a pre-defined threshold set by the network provider. If the volumes have exceeded the pre-defined threshold, the method proceeds to step 330; otherwise, the method proceeds to step 310. In step 330, the method raises an alarm to warn the network operator of a potential or impending network overload condition. In step 340, the method 300, if necessary, takes corrective action by activating the appropriate standby network element(s) to help prevent potential or impending network overload that is caused by access network or link failure. The appropriate standby network elements can be activated by the method when processing load on those particular network elements, such as BE, reach a capacity threshold pre-defined by the network provider. The method then proceeds back to step 310.

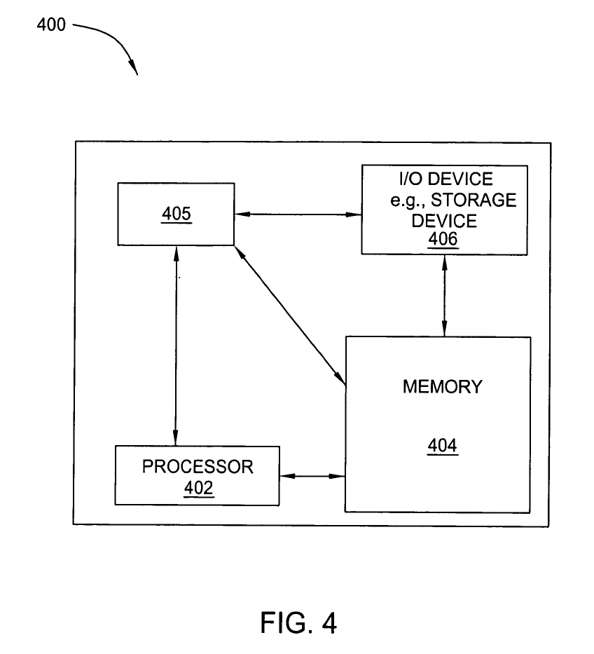

FIG. 4 depicts a high level block diagram of a general purpose computer suitable for use in performing the functions described herein. As depicted in FIG. 4, the system 400 comprises a processor element 402 (e.g., a CPU), a memory 404, e.g., random access memory (RAM) and/or read only memory (ROM), a busy and no answer conditions monitoring module 405, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present busy and no answer conditions monitoring module or process 405 can be loaded into memory 404 and executed by processor 402 to implement the functions as discussed above. As such, the present busy and no answer conditions monitoring process 405 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for monitoring surges in busy or no answer conditions in a communication network, comprising:
monitoring busy or no answer conditions of phone calls at a Border Element (BE) within said communication network; and
raising an alarm indication if a number of busy or no answer conditions phone calls exceeds a pre-defined threshold for a pre-defined period of time.

2. The method of claim 1, wherein said communication network is a Voice over Internet Protocol (VoIP) network or a Service over Internet Protocol (SoIP) network.

3. The method of claim 1, wherein said alarm indication is raised by said Border Element.

4. The method of claim 1, wherein said pre-defined threshold is set by a network provider of said communication network.

5. The method of claim 1, further comprises:
activating at least one standby network element in response to said pre-defined threshold being exceeded.

6. The method of claim 5, wherein said at least one network element comprises at least one of: a Call Control Element (CCE), a Border Element, an Application Server (AS), and a Media Server (MS).

7. The method of claim 5, wherein said at least one standby network element is a hot standby network element.

8. A computer-readable medium having stored thereon a plurality of instructions, the plurality of instructions including instructions which, when executed by a processor, cause the processor to perform the steps of a method for monitoring surges in busy or no answer conditions in a communication network, comprising:
monitoring busy or no answer conditions of phone calls at a Border Element (BE) within said communication network; and
raising an alarm indication if a number of busy or no answer conditions phone calls exceeds a pre-defined threshold for a pre-defined period of time.

9. The computer-readable medium of claim 8, wherein said communication network is a Voice over Internet Protocol (VoIP) network or a Service over Internet Protocol (SoIP) network.

10. The computer-readable medium of claim 8, wherein said alarm indication is raised by said Border Element.

11. The computer-readable medium of claim 8, wherein said pre-defined threshold is set by a network provider of said communication network.

12. The computer-readable medium of claim 8, further comprises:
activating at least one standby network element in response to said pre-defined threshold being exceeded.

13. The computer-readable medium of claim 12, wherein said at least one network element comprises at least one of: a Call Control Element (CCE), a Border Element, an Application Server (AS), and a Media Server (MS).

14. The computer-readable medium of claim 12, wherein said at least one standby network element is a hot standby network element.

15. An apparatus for monitoring surges in busy or no answer conditions in a communication network, comprising:
means for monitoring busy or no answer conditions of phone calls at a Border Element (BE) within said communication network; and
means for raising an alarm indication if a number of busy or no answer conditions phone calls exceeds a pre-defined threshold for a pre-defined period of time.

16. The apparatus of claim 15, wherein said communication network is a Voice over Internet Protocol (VoIP) network or a Service over Internet Protocol (SoIP) network.

17. The apparatus of claim 15, wherein said alarm indication is raised by said Border Element.

18. The apparatus of claim 15, wherein said pre-defined threshold is set by a network provider of said communication network.

19. The apparatus of claim 15, further comprises:
means for activating at least one standby network element in response to said pre-defined threshold being exceeded.

20. The apparatus of claim 19, wherein said at least one standby network element is a hot standby network element.
